(19) United States
(12) Patent Application Publication
(10) Pub. No.: US 2025/0302173 A1
(43) Pub. Date: Oct. 2, 2025

(54) MIST DISPENSING UNIT AND PERSONAL CARE DEVICE COMPRISING SUCH A UNIT

(71) Applicant: KONINKLIJKE PHILIPS N.V., EINDHOVEN (NL)

(72) Inventors: HIU MAN LAM, HONG KONG (CN); SZE CHUEN CHAN, HONG KONG (CN); CHAK YUEN LAW, HONG KONG (CN)

(21) Appl. No.: 18/851,101

(22) PCT Filed: Mar. 22, 2023
(86) PCT No.: PCT/EP2023/057382

§ 371 Date: Sep. 26, 2024

(30) Foreign Application Priority Data
Mar. 29, 2022 (EP) 22164958.5

(51) Int. Cl. A45D 20/12; A45D 34/04; B05B 7/00; B05B 7/24

(52) U.S. Cl. CPC A45D 20/12; A45D 34/04; B05B 7/0081; B05B 7/2489; A45D 2200/057; A45D 2200/155

(57) ABSTRACT

In a context of personal care devices (100) comprising an air conduit portion (101) and an airflow generating mechanism configured to generate an outgoing airflow from the air conduit portion (101), a mist dispensing unit (10) is provided that is configured to be arranged downstream of the air conduit portion (101). The dispensing unit (10) serves to generate and let out a mist of a care product, and comprises a container (40) configured to contain a quantity of the care product. The container (40) is generally shaped as a hollow body at least partially surrounding an air space (13). For example, the container (40) can be one of generally ring-shaped and generally C-shaped.

### FIELD OF THE INVENTION

The invention relates to a mist dispensing unit for use in a personal care device and a personal care device comprising said dispensing unit.

### BACKGROUND OF THE INVENTION

In the field of personal care, devices are known which are capable of both blowing air to a treatment area and providing the treatment area with a care product, wherein the care product is dispensed as a mist from a dispensing unit. Examples of such devices are hair care devices such as hair dryers, and skin care devices. In various known cases, the dispensing unit is configured to be used as a removably arranged attachment of the personal care device.

CN 205624988 U and CN 214630580 U disclose examples of a dispensing unit for use in a hair dryer. When it comes to the container of the dispensing unit, CN 205624988 U discloses that the container is formed by a glass bottle containing essential oils, which glass bottle is projecting upwards from the remainder of the dispensing unit in use, thereby clearly being visible as an add-on. CN 214630580 U discloses various options in respect of the positioning of the container. According to one option, the container has a central position in the dispensing unit, which involves the advantage that the container does not project from the dispensing unit at the outside thereof, but which involves the disadvantage that the outgoing airflow is let out from a ring-shaped area around the container and cannot be strong in a center area.

### SUMMARY OF THE INVENTION

The invention is in the field of dispensing units which are configured to be arranged downstream of an air conduit portion of a personal care device. It is an object of the invention to find a way to have a positioning of the container in which the container does not project from the remainder of the dispensing unit and to guarantee a strong outgoing airflow of the personal care device at the same time, comparable to an outgoing airflow that would be obtained if the personal care device would be without the dispensing unit.

In view of the foregoing, the invention provides a dispensing unit for use in a personal care device comprising an air conduit portion and an airflow generating mechanism configured to generate an outgoing airflow from the air conduit portion, which dispensing unit is configured to be arranged downstream of the air conduit portion and comprises:
a functional arrangement configured to generate and let out a mist of a care product; and
a container configured to contain a quantity of the care product;
wherein:
the container has an outlet area for letting out the care product to the functional arrangement, and the functional arrangement has an inlet area configured to receive the care product from the outlet area of the container; and
the container is generally shaped as a hollow body at least partially surrounding an air space that is functional in the dispensing unit to allow the outgoing airflow to pass the dispensing unit at the position of the container.

It follows from the above definition that according to the invention, the container is generally shaped as a hollow body at least partially surrounding an air space that is functional in the dispensing unit to allow the outgoing airflow to pass the dispensing unit at the position of the container. Thus, in a dispensing unit that is designed in accordance with the invention, an air space is present, and the container is out of the way of that air space as a result of the container being in a position of at least partially surrounding the air space, so that the outgoing airflow can be strong in the air space while an outwardly projecting positioning of the container is avoided. In fact, the space that is available in the dispensing unit is used in a clever way, wherein conventional options of designing the container are not followed. Instead, the design of the container can be regarded as being a design in which the container is at least partially bent around the air space. It is to be noted that in this design, it is very well possible to create the container with sufficient volume to contain the care product, in other words, there is no need to decrease the volume relative to conventional options in which the container does not comply with the combination of interior positioning and air space surrounding shape.

The invention covers various options of the positioning of the air space in the dispensing unit, including an option of the air space having a more or less central position in the dispensing unit, as seen in projection in a direction of a longitudinal axis of the dispensing unit, which will hereinafter be referred to as longitudinal direction. Further, the invention covers various options of the shape of the container. According to a practical option, the container is generally ring-shaped and spans 360° about the longitudinal axis, or generally C-shaped, spanning less than 360° about the longitudinal axis. Generally speaking, it is practical if a peripheral exterior surface of the container has a generally convexly curved shape about the longitudinal axis and a peripheral interior surface of the container has a generally concavely curved shape about the longitudinal axis.

Advantageously, the dispensing unit according to the invention comprises a connection area for connection to a downstream end of the air conduit portion, wherein the connection area is substantially loop-shaped about a longitudinal axis of the dispensing unit, and wherein at least a major portion of the container is located inside an inner periphery of the connection area, as seen in projection in a direction of the longitudinal axis. The connection as mentioned may be a substantially airtight connection, in which case leakage of the outgoing airflow at the position of the connection is avoided.

It is practical if the container is removably arranged in the dispensing unit, as this allows for easy replacing and/or filling the container. For example, an embodiment of the dispensing unit is feasible in which the dispensing unit comprises a holder configured to receive and hold the container, wherein the holder comprises a wall portion configured to at least partially snugly surround the container and to facilitate receipt of the container and removal of the container through a sliding movement of the container in the holder. According to another feasible option, the holder and the container are configured to magnetically couple to each other. In the case of the container being removably arranged in the dispensing unit, it is handy if the outlet area of the container comprises a sealing arrangement configured to seal the outlet area when the container is removed from the dispensing unit. An example of such a sealing arrangement is a foil seal.

In respect of the path of the care product from the outlet area of the container to the inlet area of the functional arrangement, it is noted that it is practical if this path is sealed to avoid loss/leakage of the care product. This can be achieved if one of the inlet area of the functional arrangement and the outlet area of the container comprises a sealing ring configured for sealing abutment against a ring-shaped surface area of the other of the inlet area of the functional arrangement and the outlet area of the container.

The invention covers both an option of the container being refillable and an option of the container being provided as a (bio-degradable) disposable. In the case of the first option, it may be so that the container comprises a cover element that is either removably arranged or movable between an opened condition and a closed condition, or that the container is refillable through an opening that may be the outlet opening, to mention two practical possibilities.

Advantageously, the functional arrangement is configured to let out the mist of the care product towards at least one of the air space and an area downstream of the air space. Depending on the exact design of the dispensing unit, this may imply that the functional arrangement is configured to let out the mist of the care product in a direction other than the longitudinal direction. This may help in ensuring that a combined/mixed flow of air and care product is obtained, rather than separate flows of air and care product alongside each other.

In the context of the invention, the functional unit can be of any appropriate design. In particular, the functional unit may comprise any suitable type of nebulizer, such as a vibrating mesh type piezoelectric nebulizer. In any case, it may be practical if the dispensing unit comprises two electrodes configured to connect the functional arrangement to a power supply system of the personal care device.

The dispensing unit may be an integral part of the personal care device, but a user of the personal care device is provided with more use options of the personal care device if the dispensing unit is configured to be used as a removably arranged attachment of the personal care device. According to one practical option applying to the latter case, it may be so that the dispensing unit is configured to magnetically couple to the air conduit portion of the personal care device, which does not alter the fact that numerous alternative/additional options are covered by the invention as well. Providing the user with the possibility to remove the dispensing unit when there is no need for treatment with a care product involves the advantage that in such a case, a slimmer version of the personal care device can be used.

In a case in which it is intended to realize a moisturizing functionality of the care product, the care product may simply be water. That does not alter the fact that numerous other possibilities in respect of the care product to be dispensed from the dispensing unit are covered by the invention. Generally speaking, the care product can be any type of care product, including care products commonly known and applied as hair care products, and care products commonly known and applied as skin care products.

As indicated earlier, the invention further relates to a personal care device comprising an air conduit portion and an airflow generating mechanism configured to generate an outgoing airflow from the air conduit portion, and a dispensing unit as described here before, arranged downstream of the air conduit portion. Practical examples of the personal care device according to the invention are a hair care device such as a hair dryer, and a skin care device. Besides the airflow generating mechanism and the dispensing unit, the personal care device may comprise other useful components, including a heater arrangement configured to heat the outgoing airflow, wherein such a heater arrangement may be of any suitable design and may comprise one or more heating coils, for example. In any case, the airflow generating mechanism may be of the type comprising at least one fan.

As mentioned earlier, the dispensing unit may be configured to be used as a removably arranged attachment of the personal care device. In that case, the dispensing unit and the remainder of the personal care device including the air conduit portion and the airflow generating mechanism may be provided as a set. Such a set may further comprise one or more other attachments besides the dispensing unit.

From an esthetic point of view and for ease of operation, it is advantageous if a peripheral exterior surface of the dispensing unit is flush with a peripheral exterior surface of the air conduit portion at the downstream end thereof. The optional positioning of the container of the dispensing unit inside an inner periphery of a connection area of the dispensing unit may constitute an enabling factor in this respect. The respective peripheral surfaces may have any suitable shape, and may be generally circular or elliptical about the longitudinal axis, or may be square or rectangular about the longitudinal axis, with rounded edges, for example.

The invention also relates to a container of a dispensing unit for use in a personal care device comprising an air conduit portion and an airflow generating mechanism configured to generate an outgoing airflow from the air conduit portion, which container is generally shaped as a hollow body at least partially surrounding an air space, being one of generally ring-shaped and generally C-shaped.

The above-described and other aspects of the invention will be apparent from and elucidated with reference to the following detailed description of two practical embodiments of a dispensing unit in the context of a hair care device as an example of a personal care device.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a perspective view of a hair care device comprising a dispensing unit according to a first embodiment of the invention;

FIGS. 2 and 3 diagrammatically show perspective views of the hair care device in which the dispensing unit is shown at a distance from its operative position in the hair care device;

FIGS. 4 and 5 diagrammatically show perspective views of the dispensing unit in which a container of the dispensing unit is shown at a distance from the remainder of the dispensing unit including a front cover piece and an assembly of a functional arrangement and a container holder;

FIG. 6 diagrammatically shows a perspective view of the front cover piece and the assembly of the functional arrangement and the container holder at a distance from each other;

FIG. 7 diagrammatically shows a perspective view of a dispensing unit according to a second embodiment of the invention; and

FIG. 8 diagrammatically shows a sectional view of the dispensing unit in which the container of the dispensing unit is shown at a distance from the remainder of the dispensing unit.

### DETAILED DESCRIPTION OF THE EMBODIMENTS

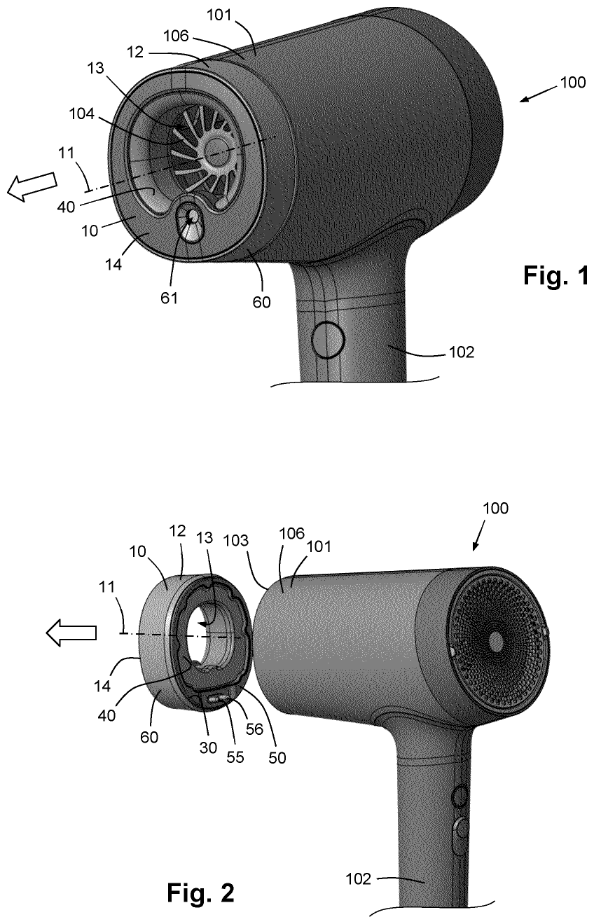

FIGS. 1-3 show views of a hair care device 100 comprising a dispensing unit 10 according to a first embodiment of the invention. The shown hair care device 100 is a hair dryer and comprises an air conduit portion 101 and an airflow generating mechanism configured to generate an outgoing airflow from the air conduit portion 101. The hair care device 100 is a handheld device and comprises a handle 102 for enabling a user to take hold of the hair care device 100.

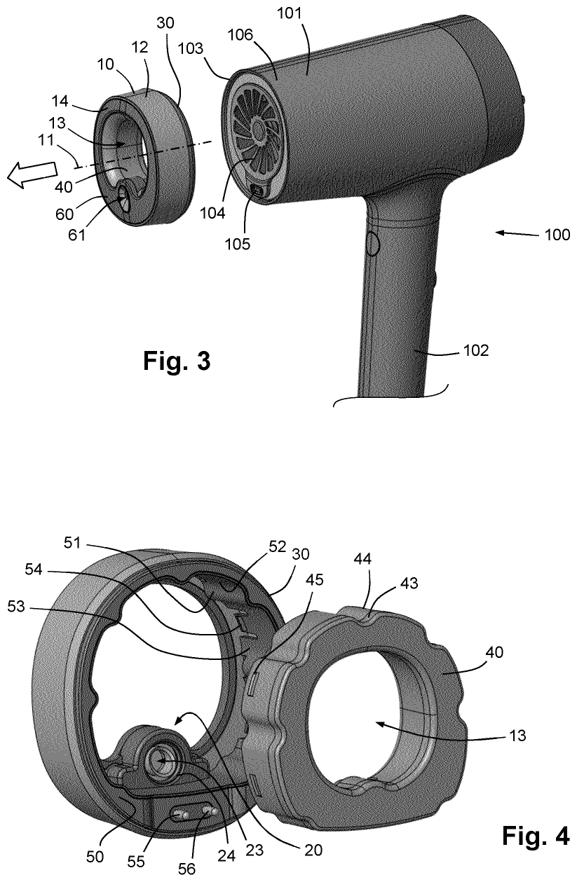

The airflow generating mechanism is arranged internally in the hair care device 100 and is not visible in FIGS. 1-3 for that reason. The same is applicable to a heater arrangement of the hair care device 100, which is useful to heat the outgoing airflow if so desired by the user. The general direction of the outgoing airflow is indicated by means of an arrow in FIGS. 1-3. At a downstream end 103 of the air conduit portion 101, the hair care device 100 comprises an outlet mesh 104 and an electrical connection area 105, as can be seen in FIG. 3. The dispensing unit 10 is configured to be arranged downstream of the air conduit portion 101 and to be coupled to the air conduit portion 101 at the downstream end 103 thereof. In the present example, as illustrated in FIGS. 2 and 3, the dispensing unit 10 is configured to be used as a removably arranged attachment of the hair care device 100, which attachment acts as passage for the outgoing airflow from the air conduit portion 101. When attached to the hair care device 100, the dispensing unit 10 and the hair care device 100 share the same longitudinal axis 11. As can be seen in FIG. 1, the design of the dispensing unit 10 is adapted to the design of the air conduit portion 101 in such a way that when the dispensing unit 10 is at the operative position in the hair care device 100, a peripheral exterior surface 12 of the dispensing unit 10 is flush with a peripheral exterior surface 106 of the air conduit portion 101 at the downstream end 103 thereof. The hair care device 100 may be equipped with any suitable means for releasably securing the dispensing unit 10 against the downstream end 103 of the air conduit portion 101.

With reference to the FIGS. 1-3 and also to FIGS. 4-6, details of the dispensing unit 10 will now be explained. In the first place, the dispensing unit 10 comprises a functional arrangement 20 that is configured to generate and let out a mist of a hair care product, which may simply be water, or water provided with suitable additions, for example. In the present example, the functional arrangement 20 comprises a vibrating mesh type piezoelectric nebulizer 21 having a nebulizer outlet 22 from which the mist of the hair care product is emitted during operation of the nebulizer 21. In the second place, the dispensing unit 10 comprises a connection area 30 for substantially airtight connection to the downstream end 103 of the air conduit portion 101, the connection area 30 being ring-shaped about a longitudinal axis 11 of the dispensing unit 10. In the third place, the dispensing unit 10 comprises a container 40 configured to contain a quantity of the hair care product. In the present example, the container 40 has a generally ring-shaped appearance and is arranged so as to surround an air space 13 of the dispensing unit 10. During operation of the hair care device 100 comprising the dispensing unit 10, the outgoing airflow flows through the air space 13 and exits the hair care device 100 at a downstream end 14 of the dispensing unit 10. Further, the container 40 is located inside an inner periphery of the connection area 30, as seen in projection in a direction of the longitudinal axis 11, in other words, in a longitudinal direction.

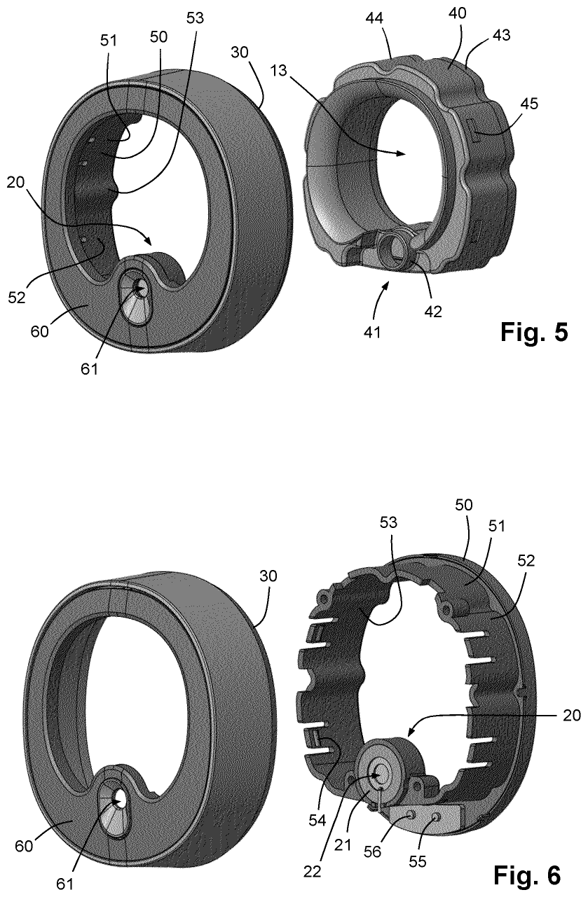

The container 40 has an outlet area 41 where the hair care product is let out towards an inlet area 23 of the functional arrangement 20 during operation. As can be seen in FIGS. 4 and 5, the outlet area 41 comprises a tube-shaped body 42, and the inlet area 23 of the functional arrangement 20 comprises a sealing ring 24 that serves to sealingly receive a free end of the tube-shaped body 42. In the present example, the container 40 is removably arranged in the dispensing unit 10. In this respect, it is noted that the outlet area 41 can be equipped with any suitable type of sealing arrangement. The container 40 comprises a cover element 43 that is removably arranged so as to enable (re) filling the container 40 with the care product. The container 40 is suitable to receive the care product directly from a supply or to receive the care product in a sleeve having an outlet that is couplable to the outlet area 41 of the container 40 from inside of the container 40.

As can be derived from FIGS. 4-6, the dispensing unit 10 comprises three main components, namely the container 40, an assembly 50 of the functional arrangement 20 and a container holder 51, and a front cover piece 60. The container holder 51 comprises a wall portion 52 configured to snugly surround the container 40, wherein a shape of a peripheral interior surface 53 of the wall portion 52 and a shape of a peripheral exterior surface 44 of the container 40 are adapted to each other, with corresponding bulges and notches. Receipt of the container 40 in the container holder 51 and removal of the container 40 from the container holder 51 can be established on the basis of a sliding movement of the container 40 in the container holder 51, in the longitudinal direction. Further, both the container 40 and the container holder 51 are provided with respective elements 45, 54 for securing the container 40 in place in the container holder 51 on the basis of a snap connection. The assembly 50 of the functional arrangement 20 and the container holder 51 further includes two electrodes 55, 56 for connection of the functional arrangement 20 to a power supply system of the personal care device 100 through the electrical connection area 105 that is present at the downstream end 103 of the air conduit portion 101.

The front cover piece 60 serves to accommodate the assembly 50 of the functional arrangement 20 and the container holder 51 and comprises the connection area 30 and a mist outlet opening 61 at the position of the nebulizer outlet 22. It is to be noted that it is advantageous if the mist of the care product is let out from the nebulizer outlet 22 and the mist outlet opening 61 in such a way that the mist is directed towards an area downstream of the air space 13, i.e. is let out in a direction different from the longitudinal direction, aimed towards the longitudinal axis 11, as in that way, an actual, mixed combination of a drying airflow and a hair care product can be provided towards the same target position on the hair under treatment.

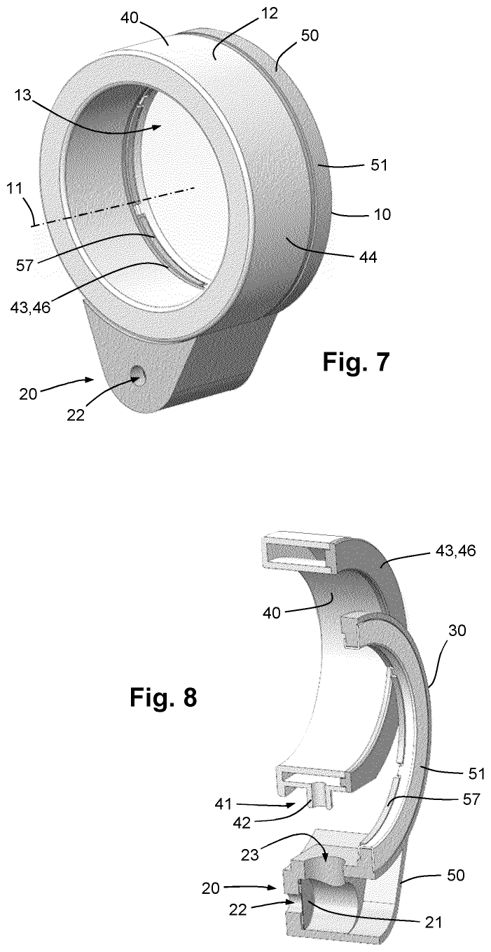

FIGS. 7 and 8 show views of a dispensing unit 10 according to a second embodiment of the invention, which will hereinafter be referred to as alternative dispensing unit 10. The alternative dispensing unit 10 has many features in common with the above-described dispensing unit 10 according to the first embodiment of the invention, and only notable different features of the alternative dispensing unit 10 will now be described.

In the first place, it is noted that in the alternative dispensing unit 10, the container 40 is removably arranged on an assembly 50 of the functional arrangement 20 and a ring-shaped container holder 51, while in comparison to the dispensing unit 10 according to the first embodiment of the invention, a front cover piece 60 is omitted. The fact is that in the alternative dispensing unit 10, the container 40 is positioned above a portion of the functional arrangement 20 and downstream of the container holder 51 when the container 40 is in place in the dispensing unit 10. In view of the fact that the position of the container 40 is downstream of the container holder 51 instead of inside of the container holder 51, part of the peripheral exterior surface 12 of the dispensing unit 10 is constituted by the peripheral exterior surface 44 of the container 40. According to a practical option, the container 40 is configured to magnetically couple to the container holder 51, wherein both the container 40 and the container holder 51 comprise one or more magnetic pieces 46, 57 at appropriate positions. This renders the alternative dispensing unit 10 very user-friendly since having a coupling of the magnetic type allows for easy removal and placement of the container 40 in the dispensing unit 10.

In comparison to the dispensing unit 10 according to the first embodiment, the alternative dispensing unit 10 is of a simpler technical design, wherein, among other things, the container 40 is generally shaped like a hollow annular ring and the peripheral exterior surface 44 of the container 40 has a smooth appearance. In general, in the alternative dispensing unit 10, there are more smooth surfaces than in the dispensing unit 10 according to the first embodiment, which does not only involve advantages as far as esthetic aspects of the dispensing unit 10 are concerned, but also in respect of cleanability, for example.

Further, it is noted that in the alternative dispensing unit 10, the functional arrangement 20 is positioned outside of the inner periphery of the connection area 30, as seen in projection in the longitudinal direction. The tube-shaped body 42 of the outlet area 41 of the container 40 extends radially from the container 40, and the inlet area 23 of the functional arrangement 20 is located at a top side of the functional arrangement 20. Contrariwise, in the dispensing unit 10 according to the first embodiment, the tube-shaped body 42 of the outlet area 41 of the container 40 extends in the longitudinal direction, and the inlet area 23 of the functional arrangement 20 is located at an upstream side of the functional arrangement 20.

It will be clear to a person skilled in the art that the scope of the invention is not limited to the examples discussed in the foregoing, but that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in this text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

A feasible modification to the design of the above-described alternative dispensing unit 10 relates to the way in which the functional arrangement 20 is positioned in the dispensing unit 10. For example, the position of the functional arrangement 20 may be a top position instead of the bottom position, such that the container 40 is positioned below a portion of the functional arrangement 20 when the container 40 is in place in the dispensing unit 10, wherein the outlet area 41 of the container 40 is at a top side of the container 40 and the inlet area 23 of the functional arrangement 20 is at a bottom side of the functional arrangement 20. In this respect, it is noted that in general, a pumping arrangement or the like may be used to transport the care product from the container 40 to the functional arrangement 20. On the other hand, at least in a number of feasible embodiments of the dispensing unit 10, it is possible to rely on natural phenomena such as gravity, capillary action and venturi action for this purpose.

The term “mist of a care product” as used in the present text is to be understood so as to cover drops or droplets of a care product. In view thereof, a possible alternative wording of the term is “spray of a care product”.

The terms “downstream” and “upstream” as used in the present text refer to an operational position of the dispensing unit 10 on a personal care device 100, in particular to the flow direction of the outgoing airflow from the air conduit portion 101 of the personal care device 100 through the air space 13 of the dispensing unit 10 in said operational position.

In respect of the terms “ring” and “ring-shaped” as used in the present text, it is noted that a ring does not necessarily need to have a circular appearance. Further, in respect of terms assuming an orientation of components, particularly a normal operational orientation of components such as reflected in the figures, it is noted that the use of such terms is in no way to be understood so as to be limiting the scope of the invention.

Notable aspects of the invention are summarized as follows. In a context of personal care devices 100 comprising an air conduit portion 101 and an airflow generating mechanism configured to generate an outgoing airflow from the air conduit portion 101, a mist dispensing unit 10 is provided that is configured to be arranged downstream of the air conduit portion 101. The dispensing unit 10 serves to generate and let out a mist of a care product, and comprises a container 40 configured to contain a quantity of the care product. The container 40 is generally shaped as a hollow body at least partially surrounding an air space 13. For example, the container 40 can be one of generally ring-shaped and generally C-shaped. In any case, it may be practical if the container 40 is arranged so as to at least partially surround the air space 13 while spanning at least 180° about a longitudinal axis 11 of the dispensing unit 10.

1. Dispensing unit for use in a personal care device, the personal care device comprising an air conduit portion and an airflow generating mechanism configured to generate an outgoing airflow from the air conduit portion, which dispensing unit is configured to be arranged downstream of the air conduit portion and comprises:
a functional arrangement configured to generate and let out a mist of a care product; and
a container configured to contain a quantity of the care product;
wherein:
the container has an outlet area for letting out the care product to the functional arrangement, and the functional arrangement has an inlet area configured to receive the care product from the outlet area of the container;
the container is generally shaped as a hollow body at least partially surrounding an air space that is functional in the dispensing unit to allow the outgoing airflow to pass the dispensing unit at the position of the container; and
a connection area for connection to a downstream end of the air conduit portion, wherein the connection area is substantially loop-shaped about a longitudinal axis of the dispensing unit, and wherein at least a major portion of the container is located inside an inner periphery of the connection area, as seen in projection in a direction of the longitudinal axis.

2. The dispensing unit as claimed in claim 1, wherein the container is one of generally ring-shaped and generally C-shaped.

3. The dispensing unit as claimed in claim 1, wherein the container is removably arranged in the dispensing unit.

4. The dispensing unit as claimed in claim 3, comprising a holder configured to receive and hold the container, wherein the holder comprises a wall portion configured to at least partially snugly surround the container and to facilitate receipt of the container and removal of the container through a sliding movement of the container in the holder.

5. The dispensing unit as claimed in claim 3, comprising a holder configured to receive and hold the container, wherein the holder and the container are configured to magnetically couple to each other.

6. The dispensing unit as claimed in claim 1, wherein the container comprises a cover element that is either removably arranged or movable between an opened condition and a closed condition.

7. The dispensing unit as claimed in claim 1, wherein the functional arrangement is configured to let out the mist of the care product towards at least one of the air space and an area downstream of the air space.

8. The dispensing unit as claimed in claim 1, comprising two electrodes configured to connect the functional arrangement to a power supply system of the personal care device.

9. The dispensing unit as claimed in claim 1, wherein the dispensing unit is configured to be used as a removably arranged attachment of the personal care device.

10. The dispensing unit as claimed in claim 9, configured to magnetically couple to the air conduit portion of the personal care device.

11. A personal care device, comprising an air conduit portion and an airflow generating mechanism configured to generate an outgoing airflow from the air conduit portion, and a dispensing unit as claimed in claim 1, arranged downstream of the air conduit portion.

12. The personal care device as claimed in claim 11, wherein a peripheral exterior surface of the dispensing unit is flush with a peripheral exterior surface of the air conduit portion at a downstream end thereof.

13. The personal care device as claimed in claim 11, comprising a heater arrangement configured to heat the outgoing airflow.
